(19) United States
(12) Patent Application Publication
(10) Pub. No.: US 2004/0189510 A1
(43) Pub. Date: Sep. 30, 2004

(54) Intrusion identification system using microwave barrier

(76) Inventors: Giovanni Negro, Baldiserro (IT); Rinaldo Condello, Venaria (IT)

Correspondence Address: Karin H Butchko, Carson Gaskey & Olds, 400 W Maple, Suite 350, Birmingham, MI, 48009, US

(21) Appl. No.: 10/486,636

(22) PCT Filed: May 13, 2002
(86) PCT No.: PCT/EP02/05228

(30) Foreign Application Priority Data
Aug. 16, 2001 (EP) 01830541.7

(51) Int. Cl. G01S 13/62

(52) U.S. Cl. 342/28; 342/114; 342/109; 342/111; 340/541; 340/554

(57) ABSTRACT

The intrusion detection system comprises a pair of narrow-beam microwave detectors exploiting Doppler effect and independently operating. A processing unit analyses the signals received by both detectors versus time and Doppler frequencies and amplitude. Analysis of such data allows detecting an actual intrusion. The processing unit also analyses the steady presence of the radio-frequency signal at each detector, to ascertain possible failures or tampering of the system.

This application is the National Stage of PCT application PCT/EP02/05228 filed on May 13, 2002, which claims priority to EP 01830541.7 filed on Aug. 16, 2001.

### BACKGROUND OF THE INVENTION

In the field of alarm systems and anti-theft systems for civil and industrial premises, there are known intrusion detection devices using volumetric detectors and anti-intrusion barriers operating in the microwave frequency range, typically 2 to 40 GHz. Such devices are capable of signalling the movement of a persons even moving at the minimum possible speed.

Generally, such devices includes a transmitter and a receiver facing each other. The transmitter sends towards the receiver a microwave beam, continuous or preferably pulse-modulated, to reduce consumption and decrease the average emission power, and the beam is converted at the receiver into a reference signal representing the rest condition of the barrier. In case the microwave beam is crossed by a solid body, there is an attenuation of the beam and hence a variation in the signal level at the receiver.

Yet such technique intrinsically lacks precision, since it does not allow distinguishing among beam crossing by two bodies of different sizes at different distances from the receiver, which bodies are however seen by the receiver under a same angle. For instance, a small animal near the receiver can be confused with a person far from the receiver. Thus, a high number of false alarms are produced. Even by employing sophisticated signal processing, it is impossible to establish accurately or with a high probability whether the barrier crossing is actually due to a person.

### SUMMARY OF THE INVENTION

It is an object of the invention to provide an intrusion detection system that provides a substantially accurate indication of whether the intrusion is caused by a person.

The detection system according to the invention includes at least one pair of facing Doppler-effect detectors equipped with a respective transmitting-receiving antenna for sending towards the remote detector a very narrow microwave beam and for receiving a corresponding beam reflected by a body possibly crossing the transmitted beam. The detectors generate electrical signals representative of the reflected beam The system also includes a control unit connected to both detectors and including a system for processing the electric signals arranged to analyse the frequency and the amplitude of the signals to detect the presence of the body, to determine the size thereof and to signal the intrusion in case the beam crossing by a body of predetermined size, in particular a human being, is detected.

### BRIEF DESCRIPTION OF THE DRAWINGS

FIG. 1 is a diagram illustrating the principles of the device according to the invention;

FIGS. 2 and 3 are diagrams showing two different situations of barrier crossing by a target;

FIG. 4 is a chart of the equivalent gain versus the target surface;

FIG. 5 is a block diagram of the device according to the invention;

FIG. 6 is a chart of the time relations of the operations carried out by both detectors;

FIG. 7 is a chart of the reflected power measured at one of the detectors of the system shown in FIG. 5 in case of a small animal and a person; and

FIG. 8 is a chart of the reflected power for both detectors of the system.

### DETAILED DESCRIPTION OF THE PREFFERED EMBODIMENT

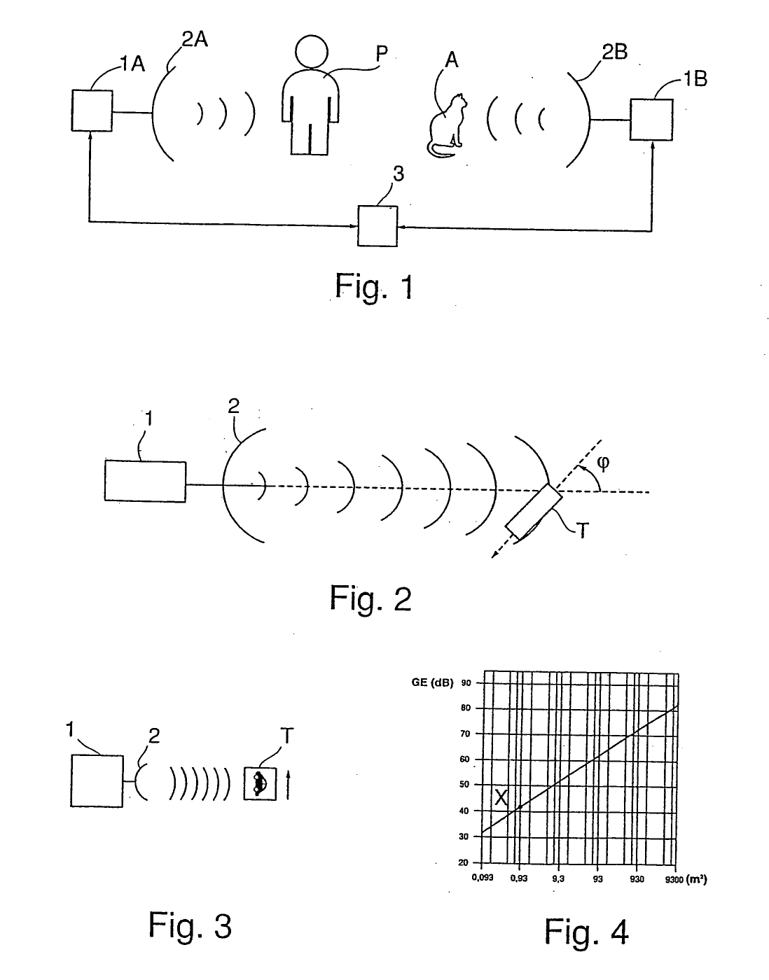

Referring to FIG. 1, the system according to the invention includes a pair of Doppler-effect volumetric detectors 1A, 1B associated with a respective transmitting-receiving antenna 2A, 2B. The detectors 1A, 1B face each other and are arranged to generate a respective microwave beam at a frequency in the range typical of anti-intrusion applications (from some GHz to some ten GHz, e.g. 2 to 40 GHz) and to operate independently of each other. Each detector 1A, 1B receives the beam reflected by a possible intruder body (target) and outputs an own electric signal representing the reflected beam and affected by the target in a manner independent of the signal generated by the other detector. Processing means in a control unit 3 receives the electric signals and processes them to detect an actual intrusion.

By such an arrangement, a check on the possible target is made from two different positions. For a given target at a given distance, the signals from both detectors will have a well defined relation. By comparing the signals, the size of the target will be positively determined, thereby ascertaining whether such target is actually the target to be detected, for instance a person P shown in FIG. 1. Indeed, the system is capable of determining when the barrier is crossed by a small animal A, for instance a bird, a dog or a cat, thereby avoiding false alarms.

When the action range is crossed by a target, a Doppler-effect detector generates an electrical signal that is obtained from the reflected beam and that, with respect to the transmitted beam, has a frequency variation proportional to the speed and the direction of the target displacement. Is also known that the target size and the target distance from the detector affect the power of the reflected signal and hence the amplitude of the signal generated by the detector.

More particularly, as far as the frequency is concerned, the variation Fd due to Doppler effect is given by:

Fd=2V (fo/c) cosφ (1)

where:

fo=transmitter frequency (Hz)

c=speed of light

V=target speed (m/s)

φ=angle between the beam and target directions.

A frequency variation of the received signal therefor allows for detecting a target displacing relative to the barrier beam, as shown in FIG. 2. It is to be appreciated that in case of a target moving perpendicularly to the beam (FIG. 3), theoretically Fd=0. Yet, a body approaching the beam range of action causes an instant frequency variation that disappears when the body leaves the visibility range of the barrier, so that also such a situation can be detected.

Equivalent gain GE is a parameter increasing as the target area increases. The behavior of GE versus the area is shown in FIG. 4 for a 10 GHz radar signal. For the purposes of the present invention, point X of the straight line (located at about 42 dB) is of interest, since it is the value of GE corresponding to a human body of average size. Assuming a target corresponding to a human being, distance d can be determined by using relations (2) and (3). Conversely, if the distance d is known, GE can be determined and the target size can be obtained therefrom.

In the control unit 3, the above relations will be conveniently applied and an analysis of the results will be performed by taking into account all parameters that, during construction, sensibly modify the theoretical calculations. Thus, a highly precise result can be obtained which meets the essential requirements of the invention, i.e., detecting an intrusion without generating false detections due to the limits of the environment where the barrier is located.

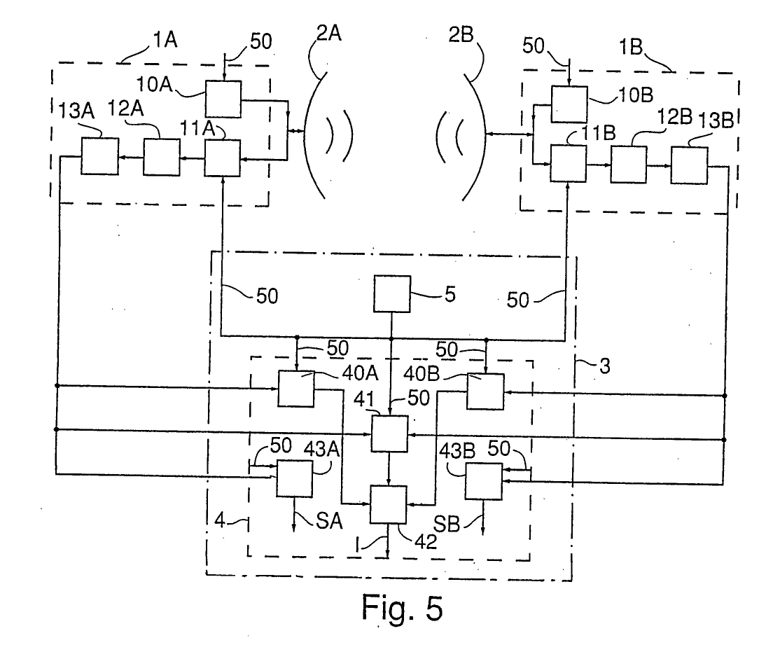

A preferred embodiment of a barrier device according to the invention will be now described with reference to FIGS. 5 to 8.

In the block diagram of FIG. 5, the elements already disclosed with reference to FIG. 1 are denoted by the same reference numerals. The pairs of detectors 1A, 1B are located facing each other, according to conventional procedures, in the areas to be watched, (usually outside buildings) to create anti-intrusion barriers. The detectors will have a range exceeding the range desired for the system. The respective antennas 2A, 2B are such as to ensure a narrow-beam coverage of the watched area. Reference numerals 10A, 10B denote the oscillators that form the transmitting part of the detectors 1A, 1B and generate intermittent (pulsed) signals at the desired frequency. Reference numerals 11A, 11B denote the receivers.

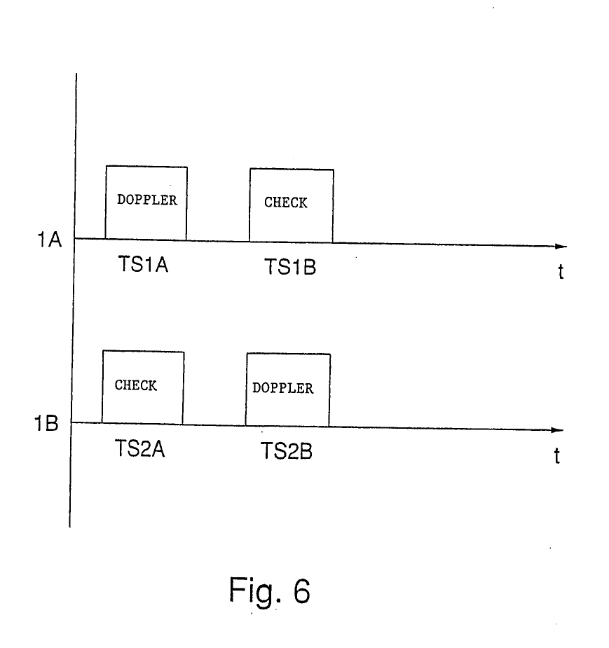

The detectors 1A, 1B must operate independently of each other and they must not give rise to interference between the two beams. This may be achieved through an alternate operation of the detectors 1A, 1B. The control unit 3 will thus include, besides system 4 for processing the signals coming from the receivers 1A, 1B, a synchronisation system 5 connected to the transmitters 10A, 10B and the receivers 11A, 11B through a line 50 to establish the desired alternation between the operations of detectors 1A, 1B. More particularly, the synchronisation systems 5 may create different operation time slots for each detector 1A, 1B, and the detector 1A,1B will perform different functions in the different time slots. For instance, as shown in FIG. 6, a first time slot TS1A and TS2B, respectively, may be devoted to the operation related with the actual intrusion detection. Such a first slot is labelled “Doppler”. A second time slot TS1B and TS2A, respectively, (“Check”) may be devoted to a functionality check on the device, to detect barrier malfunctioning or tampering, such as modifications of the orientation or removal of a detector 1A, 1B. In, practice, that functionality check may be carried out by detecting, at each detector, the steady presence of the signal emitted by the other detector or the presence of an anti-masking code. In case of pulse transmission, the presence of a pulse is recognized because of the reception of the same pulse at the opposed detector, the presence being steady even though intermittent. An anti-masking code is instead a complex code univocally indicating the occurrence of a transmission; the code must be always present, and its absence indicates a masking or a tampering.

Advantageously, the two slots will be organized so that while a detector 1A 1B carries out the operations related with intrusion detection, the other one performs the operations related with functionality check.

Besides receivers 11A, 11B, the detectors 1A, 1B further include respective analogue amplifiers 12A, 12B, which amplify the signals generated by the receivers 11A, 11B and send the amplified signals to coherence verification circuits 13A, 13B, respectively. This structure for the Doppler-effect detectors 1A, 1B is conventional. The coherence verification circuits 13A, 13B check that the received signal has a certain coherence with respect to a mask, indicating that the beam has been crossed by a target. Possible electrical or radio-electrical noises or noises of other kinds, giving rise to a “false” detection of a movement, are partly eliminated at this circuit level.

The signals outgoing from the coherence verification circuits 13A, 13B are then fed to the processing system 4. The processing system 4 includes, as main components, a pair of circuits 40A, 40B that analyze the frequency of the signals supplied by detectors 1A, 1B and a circuit 41 that analyzes the amplitude of those signals. The circuits 40A and 40B, as well as circuit 41, receive timing and/or enabling signals from the synchronising system 5 through the line 50.

The circuits 40A, 40B check whether the received signals actually have undergone the frequency variations caused by a moving target crossing the beam, that is variations meeting relation (1) or corresponding with those due to a target perpendicularly crossing the beam. In the affirmative, the circuits 40A, 40B generate a respective signal indicating that a moving target has been detected.

The amplitude analysis circuit 41 determines the size of the target crossing the barrier. To this aim, the circuit 41 will check whether the power of the reflected beam received by each detector 1A, 1B during time slots TS1A, TS2B (FIG. 6) corresponds with the power the beam should have if crossed by a human being, and whether the ratio between the two power values is the ratio due to beams reflected by a human being towards detectors 1A, 1B. Even the circuit 41 will output, in case of successful result of the checks, a signal indicating that detection has taken place.

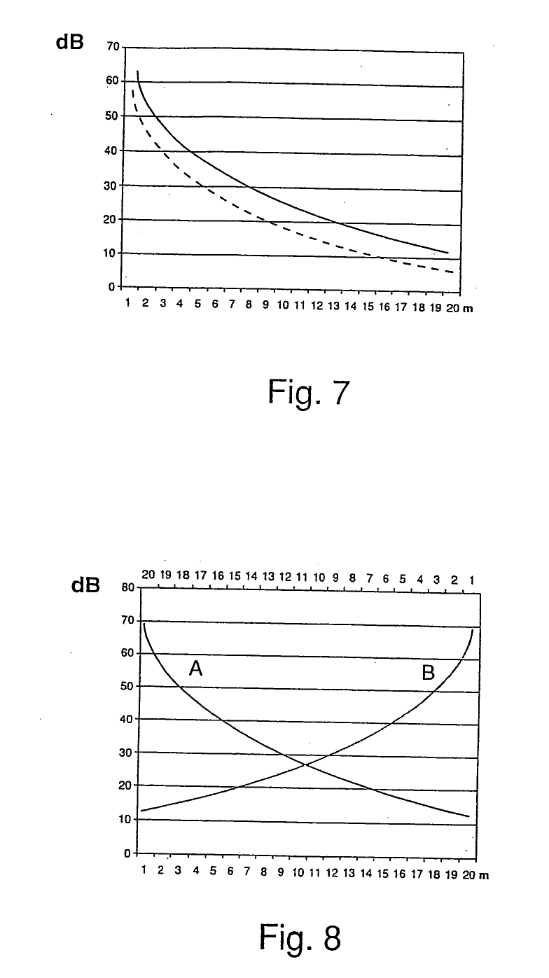

In order to better understand those operations, the charts in FIGS. 7 and 8 can be considered. Those charts show the power reflected by a target (and more particularly the power level above the noise background) versus the distance from the detectors 1A, 1B. The charts are plotted by applying relations (2) and (3) and assuming, by way of example, that the frequency of transmitters 10A, 10B is 10.4 GHz, the antenna gain is +13 dB, the transmitter output power is 10 mW, the receiver sensitivity is −90 dB and the distance between the detectors is 20 m. FIG. 7 shows the behavior of the power reflected by a human being (solid line) and by a small animal (dashed line). The two curves are substantially parallel to each other but, being the reflected power proportional to GE (see relation (2) and FIG. 4), the values for a human being always exceed by some dB the values for a small animal. FIG. 8 shows the behavior of the level above the noise background for the power reflected by a human being towards detectors 1A, 1B (curves A, B). The distances from the detector 1A are indicated below the chart and the distances from the detector 1B are indicated above the chart, Of course, the two curves are symmetrical and will cross at half the distance from the detectors 1A, 1B (10 m in the example).

Thus, a comparison between the power values concerning both detectors 1A, 1B allows the determination of whether the detectors 1A, 1B receive beams reflected by a same target (both values must lie on a same vertical line in FIG. 8) and hence determining the distance between the target and each detector 1A, 1B. Once the distance has been determined, the values of the individuals signals allow ascertaining whether the target actually is a human being.

As a numerical example, let us assume that the value detected by one detector, e.g. detector 1A, exceeds the value of the other detector by about 20 dB. This indicates that the target is 5 m far from detector 1A and 15 m far from detector 1B (see FIG. 8). For the target to be considered a human being, the amplitudes of such signals must correspond to levels above noise of about 35 dB for the signal of the detector 1A and of about 15 dB for the signal of the detector 1B.

The circuits 40A, 40B, 41 are then followed by a circuit 42 generating a detected intrusion signal. If all three circuits have emitted a signal of occurred detection, the circuit 42 generates the detected intrusion signal I for actuating an alarm device (not shown).

The processing system 4 further includes circuits 43A, 43B for detecting the signal used for the functionality check (which signal is assumed to be generated by coherence verification the circuits 13A, 13B), which generate respective alarm signals in case detection does not take place. The nature of such circuits 43A, 43B depends on the check carried out. Of course, such circuits 43A, 43B will operate only during slots TS2A, TS1B and will receive the proper enabling and/or timing signals from the synchronisation system 5.

The device of the invention has been disclosed with reference to a particular exemplary embodiment. However, the skilled in the art will readily recognize that several modified embodiments exist within the same inventive principle. More particularly, the beams generated by the detectors may have different frequency and/or polarisation and the alternate operation can be used jointly with the frequency and/or polarisation diversity. Moreover, the architecture shown for control unit 3 is merely a functional architecture: in practice, the circuits 40A, 40B, 41 and 42 could be made by a pair of frequency detectors and a pair of amplitude detectors (or a single frequency detector and a single amplitude detector alternately connected to the detectors 1A, 1B) supplying with the detected values a processing unit that carries out the analysis described above and performs also the tasks of circuit 42. Moreover, that unit could be connected also to circuits 43 and generate alarm signals SA, SB.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. An intrusion detection system using a microwave barrier comprising an
at least one pair of facing Doppler-effect detectors each equipped with a respective transmitting-receiving antenna for transmitting toward the remote detector a microwave beam and for receiving at least one corresponding reflected beam reflected by a body crossing the transmitted beam, the detectors generating electrical signals representative of the reflected beam; and
a control unit connected to both the detectors and including a processor for processing the electric signals, the processor is arranged to analyse a frequency and an amplitude of the electric signals to detect a presence of the body, to determine a size of the body and to signal an intrusion the body has a predetermined size.

2. The system according to claim 1, wherein the processor comprises a frequency measuring and analyzing device connected to both the detectors and arranged to receive the electric signals, to detect whether the electric signals have undergone frequency variations corresponding to variations induced by Doppler effect caused by the body crossing the transmitted beam, and to output a frequency signal if a frequency variation has occurred and an amplitude measuring and analyzing device connected to both the detectors and arranged to receive the electric signals, to compare the amplitude of the electric signals to check whether the electric signals are representative of the reflected beam reflected by the body and to determine the distance of the body from both the detectors, to detect, based on the amplitude of the electric signals and on the distance of the body, whether the body has the predetermined size and to output an amplitude signal indicating that the body of the predetermined size has been detected taken place.

3. The system according to claim 2, wherein the processor further comprises an intrusion signalling device connected to the frequency analyzing device and the amplitude analyzing device that generates an intrusion signal when both the frequency analyzing device generates a frequency signal and the amplitude analyzing device generates an amplitude signal

4. The system according to claim 1, wherein the processing comprises a device for measuring the frequency and the amplitude of the electric signals generated by the detectors and a processing unit connected to the device for measuring and arranged to analyse the frequency of the electric signals to detect frequency variations corresponding to variations induced by Doppler effect by body crossing the transmitted beam, to compare the amplitude of the electric signals to check whether the electric signals correspond to a powers of the reflected beam by the body and determine distance of the body from both the detectors, to check whether the amplitude of the electric signals correspond to the powers of the reflected beam by a the body of the predetermined size spaced apart from the detectors by the distances determined, and to generate a an intrusion signal if analysis of the amplitude and the frequency reveals that the transmitted beam has been crossed by a body of the predetermined size.

5. The system according to claim 1, wherein the processor generates the intrusion signal when the processor detects the transmitted beam is crossed by a human being.

6. The system according to claim 1, wherein the control unit further comprises a synchronisation device to alternately operate the detectors and to time operation of the processor.

7. The system according to claim 6, wherein the synchronisation device operates the detectors in a first time slot and a second time slot, and the first one time slot is devoted to operations based on Doppler effect and the second one time slot is devoted to operations based on a functionality check of the system.

8. The system according to claim 7, wherein the synchronisation device controls the detectors and the processor, and one of the detectors carries out the operations based on Doppler and the other of the detector carries out operations related with the functionality check.

9. The system according to claim 7 wherein each of the detectors are enabled to transmit an anti-masking code towards the other of the detectors during the second time slot and to receive an anti-masking code transmitted by the other of the detectors.

10. The system according to claim 7 wherein each of the detectors is enabled to check whether the transmitted beam from the other of the detectors is present during the second time slot.

11. The system according to claim 1, wherein the processor further comprises a code detector connected to each of the detectors and operated during the second time slot for detecting the anti-masking code in the signals received by the either of the detectors.

12. The system according to claim 1l wherein the processor further comprises a code detector connected to each of the detectors and operated during the second time slot for detecting the presence of the transmitted beam from the other of the detectors.

13. The system according to claim 1, wherein the detectors to generate beams having at least one of a different frequency and a different polarization with respect to each other.

14. The system according to claim 4, wherein the processor generates the intrusion signal when the processor determines that the transmitted beam is crossed by a human being.
